(19) United States
(12) Patent Application Publication
(10) Pub. No.: US 2022/0261671 A1
(43) Pub. Date: Aug. 18, 2022

(54) PROBABILITY CONTEXTUALIZATION

(71) Applicant: International Business Machines Corporation, Armonk, NY (US)

(72) Inventors: Stephane Deparis, Dublin (IE); Charles Arthur Jochim, Dublin (IE); Pierpaolo Tommasi, Dublin (IE)

(21) Appl. No.: 17/176,209

(22) Filed: Feb. 16, 2021

(51) Int. Cl. G06N 7/00; G06F 16/242

(52) U.S. Cl. CPC G06N 7/005; G06F 16/243

(57) ABSTRACT

In an approach to explaining probabilistic answers through contextualization, one or more computer processors receive a query associated with a probability value of a first event from a user. One or more computer processors parse the query into one or more constituent parts. Based on the one or more constituent parts, one or more computer processors determine the first event. One or more computer processors query a probability value of the first event, where the second event is similar to the first event. One or more computer processors determine the probability value of the first event and the probability value of the second event are known. One or more computer processors fetch the probability value of the first event and the probability value of the second event. One or more computer processors display the probability value of the first event and the probability value of the second event.

### BACKGROUND OF THE INVENTION

The present invention relates generally to the field of natural language probabilistic queries, and more particularly to explaining probabilistic answers through contextualization.

Natural language processing (NLP) is a field of computer science, artificial intelligence, and linguistics concerned with the interactions between computers and human (natural) languages. As such, natural language processing is related to the area of human—computer interaction. Many challenges in natural language processing involve natural language understanding, that is, enabling computers to derive meaning from human or natural language input.

Probability is a branch of mathematics concerning numerical descriptions of how likely an event is to occur, or how likely it is that a proposition is true. The probability of an event can be described as a number between 0 and 1, where, roughly speaking, 0 indicates impossibility of the event and 1 indicates certainty. The higher the probability of an event, the more likely it is that the event will occur. A simple example is the tossing of a fair (unbiased) coin. Since the coin is fair, the two outcomes (“heads” and “tails”) are both equally probable; the probability of “heads” equals the probability of “tails”; and since no other outcomes are possible, the probability of either “heads” or “tails” is one half (which could be written as ½, 0.5 or 50%).

### SUMMARY

Embodiments of the present invention disclose a computer-implemented method, a computer program product, and a system for explaining probabilistic answers through contextualization. The computer-implemented method may one or more computer processors receiving a query from a user, wherein the query is associated with a probability value of a first event, and wherein the query is in a natural language. One or more computer processors parse the query into one or more constituent parts. Based on the one or more constituent parts, one or more computer processors determine the first event. One or more computer processors query a probability value of the first event, where the second event is similar to the first event. One or more computer processors determine the probability value of the first event and the probability value of the second event are known. One or more computer processors fetch the probability value of the first event and the probability value of the second event. One or more computer processors display the probability value of the first event and the probability value of the second event to the user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a contextualization program, on a server computer within the distributed data processing environment of FIG. 1, for explaining probabilistic answers through contextualization, in accordance with an embodiment of the present invention; and

FIG. 3 depicts a block diagram of components of the server computer executing the contextualization program within the distributed data processing environment of FIG. 1, in accordance with an embodiment of the present invention.

### DETAILED DESCRIPTION

Probabilities can be unintuitive and difficult to understand. Current systems for calculating likelihoods do not explain the answer. Often, when receiving an answer to a probability question or query, a user cannot contextualize the answer, i.e., understand the probability under conditions to which the user can relate. For example, a user may not be able to understand or conceptualize what is meant by “a 1 in 15,300 chance to be struck by lightning.” In addition, facts can be misleading when not properly contextualized. Embodiments of the present invention recognize that probability understanding may be improved by providing contextualization to results of probability queries. Embodiments of the present invention also recognize that by customizing results of probability queries to the user, misconceptions can be avoided. Implementation of embodiments of the invention may take a variety of forms, and exemplary implementation details are discussed subsequently with reference to the Figures.

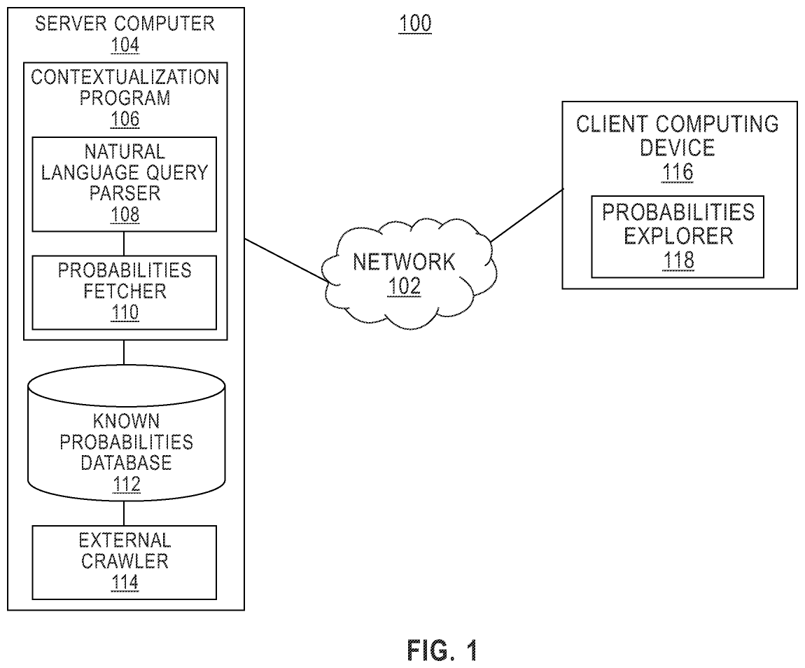

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 116 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 116, and other computing devices (not shown) within distributed data processing environment 100.

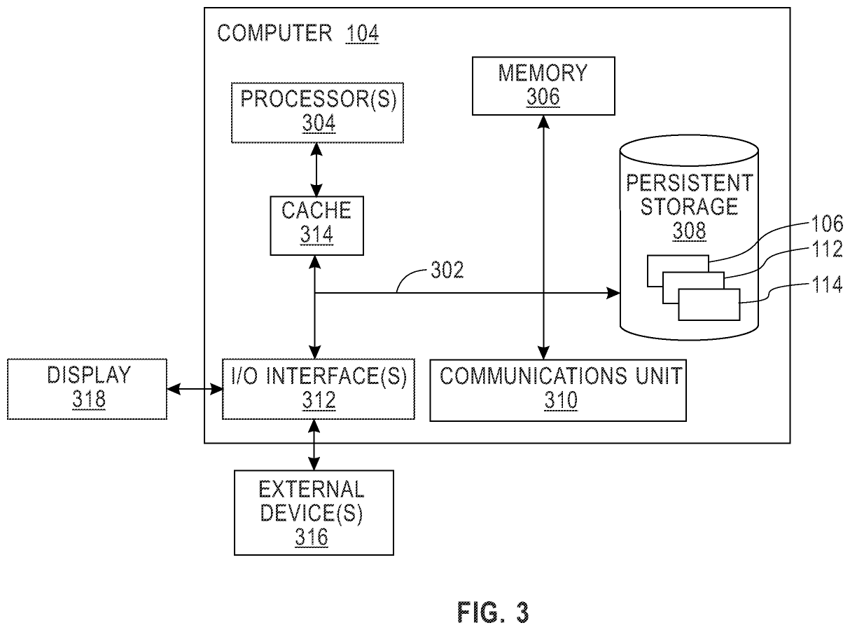

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 116 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes contextualization program 106, known probabilities database 112, and external crawler 114. Server computer 104 may include internal and external hardware components, as depicted and described in further detail with respect to FIG. 3.

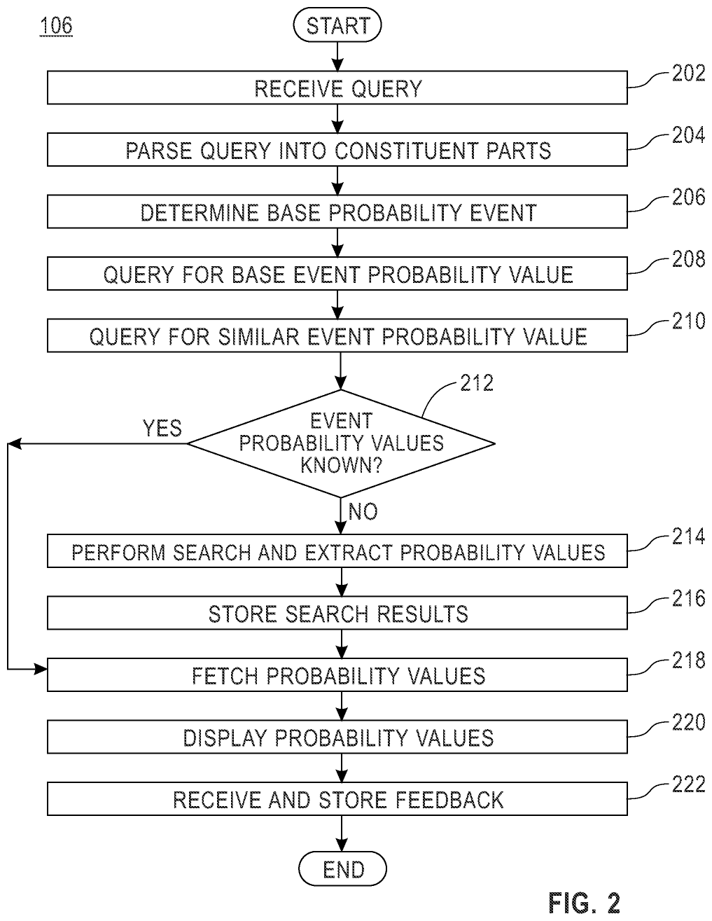

Contextualization program 106 provides a user with a probability of an occurrence of an event and a contextualization of the probability, to enable better understanding of the probability by the user. Consider an example of two friends planning a trip in the future. The first friend is concerned that the infection rate of a particular virus is currently high in the location they plan to visit. The second friend argues that the infection rate of tourists in the time frame they plan to visit is low. Contextualization program 106 can provide information such as an infection rate in similar locations or in other time periods for comparison. Contextualization program 106 can also provide a similar or known likelihood for comparison, such as, contracting the virus is as likely as winning the lottery. Thus, contextualization program 106 enables a user to better understand the probability in both a similar context and a more general context. Contextualization program 106 receives a query from a user and parses the query into constituent parts. Contextualization program 106 determines a probability event in the query based on the constituent parts. Contextualization program 106 queries for the event probability value as well as for another event having a similar event probability value. If the event probability values are not known, then contextualization program 106 performs a search, extracts a probability value, and stores the probability value. Contextualization program 106 fetches the probability values and displays the probability values to the user. Contextualization program 106 receives feedback from the user and stores the feedback. Contextualization program 106 includes natural language query parser 108 and probabilities fetcher 110. Contextualization program 106 is depicted and described in further detail with respect to FIG. 2.

Natural language query parser 108 converts a query received from a user in natural language into constituent parts such that contextualization program 106 can use the constituent parts to determine a probability event within the query. As used herein, probability event refers to an event for which a probability of occurrence can be queried and calculated. In addition, natural language query parser 108 can expand the received query using, for example, synonyms, antonyms, hypernyms, and hyponyms. In the depicted embodiment, natural language query parser 108 is a component of contextualization program 106. In another embodiment, the function of natural language query parser 108 is integrated into contextualization program 106.

Probabilities fetcher 110 fetches probabilities related to the probability event determined from the query. In addition, probabilities fetcher 110 fetches known probabilities for comparison to the probability of the event. In the depicted embodiment, probabilities fetcher 110 is a component of contextualization program 106. In another embodiment, probabilities fetcher 110 is a function integrated into contextualization program 106.

Known probabilities database 112 stores information used and generated by contextualization program 106. In the depicted embodiment, known probabilities database 112 resides on server computer 104. In another embodiment, known probabilities database 112 may reside elsewhere within distributed data processing environment 100, provided that contextualization program 106 has access to known probabilities database 112. A database is an organized collection of data. Known probabilities database 112 can be implemented with any type of storage device capable of storing data and configuration files that can be accessed and utilized by contextualization program 106, such as a database server, a hard disk drive, or a flash memory. In various embodiments, known probabilities database 112 can be a structured query language (SQL) database, a non-SQL (NoSQL) database, a knowledge base, or a combination of two or more of these. Known probabilities database 112 stores known event probabilities and associated metadata. The associated metadata may assist in providing contextualization of the probability of an event. Associated metadata may be, for example, a number of times the probability of the event has been queried. Further, associated metadata may be one or more conditions associated with the known event probabilities. In an embodiment, known probabilities database 112 is optimized to return results on a combination of metadata and probability in addition to the queried event. For example, contextualization program 106 may query known probabilities database 112 to find a well-known event with a probability of 0.005. In an embodiment, known probabilities database 112 stores a list of events, the associated probability outcome, and the associated metadata. In an embodiment, known probabilities database 112 is optimized to store related and/or sequential probabilities. For example, known probabilities database 112 stores the probability of event A and event B occurring at the same time. In another example, known probabilities database 112 stores the probability of event B occurring if event A has already occurred. Known probabilities database 112 also stores user feedback on the information provided to the user by contextualization program 106.

The present invention may contain various accessible data sources, such as known probabilities database 112, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Contextualization program 106 enables the authorized and secure processing of personal data. Contextualization program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Contextualization program 106 provides information regarding personal data and the nature (e.g., type, scope, purpose, duration, etc.) of the processing. Contextualization program 106 provides the user with copies of stored personal data. Contextualization program 106 allows the correction or completion of incorrect or incomplete personal data. Contextualization program 106 allows the immediate deletion of personal data.

External crawler 114 is one or more of a plurality of internet bots that systematically browses the web, typically for the purpose of web indexing, as would be recognized by a person of skill in the art. A search engine (not shown) may use external crawler 114 to explore the internet and report findings, for example, probability values.

Client computing device 116 can be one or more of a laptop computer, a tablet computer, a smart phone, smart watch, a smart speaker, or any programmable electronic device capable of communicating with various components and devices within distributed data processing environment 100, via network 102. Client computing device 116 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch. In an embodiment, client computing device 116 may be integrated into a vehicle of the user. For example, client computing device 116 may include a heads-up display in the windshield of the vehicle. In an embodiment, client computing device 116 may be a server computer. For example, a newspaper may automate client computing device 116 to collect probability information. In general, client computing device 116 represents one or more programmable electronic devices or combination of programmable electronic devices capable of executing machine readable program instructions and communicating with other computing devices (not shown) within distributed data processing environment 100 via a network, such as network 102. Client computing device 116 includes an instance of probabilities explorer 118.

Probabilities explorer 118 provides an interface between contextualization program 106 on server computer 104 and a user of client computing device 116. In one embodiment, probabilities explorer 118 is mobile application software. Mobile application software, or an “app,” is a computer program designed to run on smart phones, tablet computers and other mobile devices. In one embodiment, probabilities explorer 118 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. Probabilities explorer 118 enables a user of client computing device 116 to query contextualization program 106 about a probability event and to receive a display of probability information from contextualization program 106. In addition, probabilities explorer 118 enables the user to provide feedback to contextualization program 106 regarding the received information.

FIG. 2 is a flowchart depicting operational steps of contextualization program 106, on server computer 104 within distributed data processing environment 100 of FIG. 1, for explaining probabilistic answers through contextualization, in accordance with an embodiment of the present invention.

Contextualization program 106 receives a query (step 202). In an embodiment, when a user of client computing device 116 queries a probability of an event occurring, via probabilities explorer 118, contextualization program 106 receives the query. For example, in an embodiment where probabilities explorer 118 is a mobile app, prior to purchasing tickets, the user of client computing device 116 may input a query regarding the likelihood of a playoff baseball game in New York City being cancelled next Saturday due to weather.

Contextualization program 106 parses the query into constituent parts (step 204). In an embodiment, contextualization program 106 invokes natural language query parser 108 to decompose the received query into constituent parts. Continuing the previous example, natural language query parser 108 parses the query into parts such as (1) a playoff baseball game in New York City next Saturday, and (2) weather in New York City next Saturday. In an embodiment, natural language query parser 108 expands the query using one or more parts of speech, such as synonyms, antonyms, hypernyms, and hyponyms, associated with the constituent parts of the query.

Contextualization program 106 determines a base probability event (step 206). In an embodiment, based on the constituent parts of the query, contextualization program 106 determines one or more probability events for which to fetch a probability value. Continuing the previous example, contextualization program 106 determines the base probability events from the query as a playoff baseball game in New York City next Saturday, and weather, i.e., a weather condition that would cause a baseball game to be cancelled, e.g., rain, in New York City next Saturday.

Contextualization program 106 queries for the base event probability value (step 208). In an embodiment, contextualization program 106 invokes probabilities fetcher 110 to query known probabilities database 112 for a probability value associated with one or more probability events that are relevant to the user query, i.e., the base probability events. Continuing the previous example, probabilities fetcher 110 queries known probabilities database 112 for a weather forecast for New York City next Saturday including the probability of rain occurring at 7:00 pm, i.e., a typical time for a playoff game to be played. In an embodiment, contextualization program 106 may make one or more minor changes to the user query to be included in the query for the base event probability value. For example, contextualization program 106 may include the probability of other baseball teams playing in a playoff game, in other cities or on different dates, in the query.

Contextualization program 106 queries for a probability value of a similar event (step 210). In an embodiment, contextualization program 106 invokes probabilities fetcher 110 to query known probabilities database 112 for a probability value associated with one or more events that are similar to, or related to, the base event determined from the user query. Similar events may include well-known events with the same or similar probability, i.e., a probability value within a pre-defined threshold of the probability value of the base event. For example, if the probability of rain in New York City next Saturday is 50%, then probabilities fetcher 110 queries known probabilities database 112 for a probability of an event whose probability is the same or similar, such as flipping a coin. Similar events may also include events that are geographically close to the base event. For example, probabilities fetcher 110 queries known probabilities database 112 for a probability of a playoff baseball game in Philadelphia. Similar events may further include an event similar to the base event that contextualization program 106 can use as a comparison probability value to that of the base event. For example, probabilities fetcher 110 queries known probabilities database 112 for a probability of rain based on historical weather predictions and patterns in the same location during the same time of year as next Saturday. In general, probabilities fetcher 110 queries for any event that may assist in putting the base event in context, either because there is a similar event, or because the value of the probability of the base event is similar to, or can be contrasted with, a well-known event.

Contextualization program 106 determines whether the event probability values are known (decision block 212). In an embodiment, contextualization program 106 determines whether the queries performed by probabilities fetcher 110 resulted in one or more known probability values for the base event probability and/or for the similar event probability, i.e., contextualization program 106 determines whether the probability values are included in known probabilities database 112.

If contextualization program 106 determines the event probability values are not known (“no” branch, decision block 212), then contextualization program 106 performs a search and extracts probability values (step 214). In an embodiment, contextualization program 106 triggers external crawler 114 to perform a search for the unknown probability values for either the base event or the similar event, or both. External crawler 114 performs a web search and parses found probability values that result from the search. For example, external crawler 114 may search for a probability of a baseball team getting to a playoff game if the team has the current record and schedule of a New York City baseball team. Contextualization program 106 extracts the probability values from the search results. In an embodiment, if only probability values related to the base event are known, then contextualization program 106 calculates the probability value of the base event based on the related values. Contextualization program 106 combines the known probabilities to derive more complex probability values. For example, contextualization program 106 combines the probability that a New York City baseball team will play in a playoff game with the probability of rain next Saturday in New York City to calculate the probability value of the base event of the user query, i.e., the likelihood that a playoff baseball game in New York City will be cancelled next Saturday due to weather. In an embodiment, contextualization program 106 uses a logic engine (not shown) to calculate probability values.

Contextualization program 106 stores the search results (step 216). In an embodiment, contextualization program 106 stores the results of the search, i.e., the found probability values, performed by external crawler 114 in known probabilities database 112. By storing the newly extracted probability values, contextualization program 106 can use them for both the current query and future queries. In an embodiment where contextualization program 106 calculated a probability value based on related or relevant probability values, contextualization program 106 stores the calculated probability in known probabilities database 112.

Responsive to storing the search results, or if contextualization program 106 determines the event probability values are known (“yes” branch, decision block 212), then contextualization program 106 fetches the probability values (step 218). In an embodiment, once the probability values of the base event and the similar event are known and stored in known probabilities database 112, contextualization program 106 fetches the probability values from known probabilities database 112.

Contextualization program 106 displays the probability values (step 220). In an embodiment, contextualization program 106 displays one or more probability values of the base event and one or more probability values of the similar event to the user of client computing device 116, via probabilities explorer 118, enabling the user to explore the results.

For example, contextualization program 106 may display text that states, “The likelihood of a playoff baseball game in New York City being cancelled next Saturday due to weather is 50%.” Further, contextualization program 106 may display text that includes the constituent probabilities for the base event, such as “The likelihood of a playoff baseball game being played in New York City next Saturday is 75%, while the chance of rain in New York City next Saturday is 25%.” Contextualization program 106 also displays text associated with a probability of a similar event. For example, contextualization program 106 may display text that states, “The likelihood of a playoff baseball game in New York City being cancelled next Saturday due to weather is 50% which is similar to the likelihood of a tossed coin landing on heads.” By including the probability value of an event with a similar probability as the base event, contextualization program 106 contextualizes the response to the query to enable the user to better understand the results of the query. In another embodiment, contextualization program 106 may display the probability value of the base event with a contrasting probability of a well-known event. For example, contextualization program 106 may display text that states, “The likelihood of a baseball team from New York City winning a playoff game is 500 times greater than the likelihood of being struck by lightning.” In an embodiment, contextualization program 106 may display the probability values in a table. In an embodiment, contextualization program 106 also displays metadata associated with the probability values. For example, contextualization program 106 may display how many other users posed a similar query.

Contextualization program 106 receives and stores feedback (step 222). In an embodiment, when a user provides feedback for the result of the query, via probabilities explorer 118, contextualization program 106 receives the feedback. In an embodiment, subsequent to providing the result of the query, contextualization program 106 prompts the user for feedback. For example, contextualization program 106 may display a “thumbs up” icon and a “thumbs down” icon and prompt the user to rate the query results by choosing an icon. In another embodiment, contextualization program 106 may display one or more questions, or a survey, to the user, via probabilities explorer 118, and provide text boxes for the user to respond to the questions. For example, contextualization program 106 may display a question such as “Was the comparison of the base event to an event with a similar probability useful?” In another example, contextualization program 106 may display a question such as “Do you prefer the comparisons with a well-known event or with an event with a similar geographic location?” Contextualization program 106 stores the received feedback in known probabilities database 112 such that contextualization program 106 can use the feedback to learn how to improve results of future queries. Contextualization program 106 can also customize presentation of future results based on user feedback and preferences. Contextualization program 106 can sort, filter, and/or rank the feedback, and store the results in known probabilities database 112. Referring back to step 210, contextualization program 106 can use previously stored user feedback while querying for a similar event probability.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., contextualization program 106, known probabilities database 112, and external crawler 114 are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 116. In these examples, communications unit 310 includes one or more network interface cards. Communications unit 310 may provide communications through the use of either or both physical and wireless communications links. Contextualization program 106, known probabilities database 112, external crawler 114, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., contextualization program 106, known probabilities database 112, and external crawler 114 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a query from a user, wherein the query is associated with a probability value of a first event, and wherein the query is in a natural language;
parsing, by one or more computer processors, the query into one or more constituent parts;
based on the one or more constituent parts, determining, by one or more computer processors, the first event;
querying, by one or more computer processors, the probability value of the first event;
querying, by one or more computer processors, a probability value of a second event, wherein the second event is similar to the first event;
determining, by one or more computer processors, the probability value of the first event and the probability value of the second event are known;
fetching, by one or more computer processors, the probability value of the first event and the probability value of the second event; and
displaying, by one or more computer processors, the probability value of the first event and the probability value of the second event to the user.

2. The computer-implemented method of claim 1, further comprising:
receiving, by one or more computer processors, feedback from the user associated with the probability value of the first event and the probability value of the second event; and
storing, by one or more computer processors, the feedback.

3. The computer-implemented method of claim 2, further comprising:
prompting, by one or more computer processors, the user to provide the feedback.

4. The computer-implemented method of claim 1, further comprising:
determining, by one or more computer processors, at least one of the probability value of the first event and the probability value of the second event are not known;
performing, by one or more computer processors, a search for at least one of the probability value of the first event and the probability value of the second event;
extracting, by one or more computer processors, at least one of the probability value of the first event and the probability value of the second event from one or more search results; and
storing, by one or more computer processors, the at least one of the probability value of the first event and the probability value of the second event.

5. The computer-implemented method of claim 1, wherein parsing the query into the one or more constituent parts further comprises:
expanding, by one or more computer processors, the query using one or more parts of speech associated with the constituent parts of the query, and wherein the one or more parts of speech are at least one of synonyms, antonyms, hypernyms, and hyponyms.

6. The computer-implemented method of claim 1, wherein the second event is similar to the first event based on the probability value of the first event being the same as the probability value of the second event.

7. The computer-implemented method of claim 1, wherein displaying the probability value of the first event and the probability value of the second event to the user includes contextualizing the probability value of the first event with the probability value of the second event.

8. A computer program product comprising:
one or more computer readable storage media and program instructions collectively stored on the one or more computer readable storage media, the stored program instructions comprising:
program instructions to receive a query from a user, wherein the query is associated with a probability value of a first event, and wherein the query is in a natural language;
program instructions to parse the query into one or more constituent parts;
based on the one or more constituent parts, program instructions to determine the first event;
program instructions to query the probability value of the first event;
program instructions to query a probability value of a second event, wherein the second event is similar to the first event;
program instructions to determine the probability value of the first event and the probability value of the second event are known;
program instructions to fetch the probability value of the first event and the probability value of the second event; and
program instructions to display the probability value of the first event and the probability value of the second event to the user.

9. The computer program product of claim 8, the stored program instructions further comprising:
program instructions to receive feedback from the user associated with the probability value of the first event and the probability value of the second event; and
program instructions to store the feedback.

10. The computer program product of claim 9, the stored program instructions further comprising:
program instructions to prompt the user to provide the feedback.

11. The computer program product of claim 8, the stored program instructions further comprising:
program instructions to determine at least one of the probability value of the first event and the probability value of the second event are not known;
program instructions to perform a search for at least one of the probability value of the first event and the probability value of the second event;
program instructions to extract at least one of the probability value of the first event and the probability value of the second event from one or more search results; and
program instructions to store the at least one of the probability value of the first event and the probability value of the second event.

12. The computer program product of claim 8, wherein the program instructions to parse the query into the one or more constituent parts comprise:
program instructions to expand the query using one or more parts of speech associated with the constituent parts of the query, and wherein the one or more parts of speech are at least one of synonyms, antonyms, hypernyms, and hyponyms.

13. The computer program product of claim 8, wherein the second event is similar to the first event based on the probability value of the first event being the same as the probability value of the second event.

14. The computer program product of claim 8, wherein the program instructions to display the probability value of the first event and the probability value of the second event to the user includes program instructions to contextualize the probability value of the first event with the probability value of the second event.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a query from a user, wherein the query is associated with a probability value of a first event, and wherein the query is in a natural language;
program instructions to parse the query into one or more constituent parts;
based on the one or more constituent parts, program instructions to determine the first event;
program instructions to query the probability value of the first event;
program instructions to query a probability value of a second event, wherein the second event is similar to the first event;
program instructions to determine the probability value of the first event and the probability value of the second event are known;
program instructions to fetch the probability value of the first event and the probability value of the second event; and
program instructions to display the probability value of the first event and the probability value of the second event to the user.

16. The computer system of claim 15, the stored program instructions further comprising:
program instructions to receive feedback from the user associated with the probability value of the first event and the probability value of the second event; and
program instructions to store the feedback.

17. The computer system of claim 16, the stored program instructions further comprising:
program instructions to prompt the user to provide the feedback.

18. The computer system of claim 15, the stored program instructions further comprising:
program instructions to determine at least one of the probability value of the first event and the probability value of the second event are not known;
program instructions to perform a search for at least one of the probability value of the first event and the probability value of the second event;
program instructions to extract at least one of the probability value of the first event and the probability value of the second event from one or more search results; and
program instructions to store the at least one of the probability value of the first event and the probability value of the second event.

19. The computer system of claim 15, wherein the program instructions to parse the query into the one or more constituent parts comprise:
program instructions to expand the query using one or more parts of speech associated with the constituent parts of the query, and wherein the one or more parts of speech are at least one of synonyms, antonyms, hypernyms, and hyponyms.

20. The computer system of claim 15, wherein the second event is similar to the first event based on the probability value of the first event being the same as the probability value of the second event.
